(19) United States
(12) Patent Application Publication
(10) Pub. No.: US 2013/0229253 A1
(43) Pub. Date: Sep. 5, 2013

(54) LAMINATED ELECTRONIC COMPONENT AND METHOD OF MANUFACTURING LAMINATED ELECTRONIC COMPONENT

(71) Applicant: MURATA MANUFACTURING CO., LTD., Kyoto (JP)

(72) Inventors: Masaki INUI, Nagaokakyo-shi (JP); Hiromu FUKUSHIMA, Nagaokakyo-shi (JP)

(73) Assignee: MURATA MANUFACTURING CO., LTD., Kyoto (JP)

(21) Appl. No.: 13/779,513

(22) Filed: Feb. 27, 2013

(30) Foreign Application Priority Data
Mar. 2, 2012 (JP) 2012-046538

(51) Int. Cl. H01F 17/00; H01F 41/02

(52) U.S. Cl. CPC H01F 17/0013; H01F 41/0206
USPC 336/200; 156/272.4

(57) ABSTRACT

A laminated electronic component includes a first magnetic material portion, a low-magnetic-permeability portion laminated on the first magnetic material portion, a second magnetic material portion laminated on the low-magnetic-permeability portion, at least one annular or spiral coil disposed within the low-magnetic-permeability portion, and a plurality of columnar magnetic material portions disposed within the low-magnetic-permeability portion so as to extend through inside of the coil and connecting the first magnetic material portion to the second magnetic material portion.

### CROSS REFERENCE TO RELATED APPLICATIONS

The present application claims priority to Japanese Patent Application No. 2012-046538 filed on Mar. 2, 2012, the entire contents of this application being incorporated herein by reference in its entirety.

### TECHNICAL FIELD

The technical field relates to a laminated electronic component including a coil therein and a method of manufacturing the same.

### BACKGROUND

In a conventional electronic component such as a common mode choke coil, a wire is generally wound on a core made of ferrite or the like. However, downsizing is a significant challenge also for coil components, and laminated electronic components which include a coil therein and are manufactured using ceramic lamination technology have widely been used in recent years. As an example of such a laminated electronic component, Patent Document 1 (Japanese Unexamined Patent Application Publication No. 2005-268455) discloses a common mode choke coil. FIG. 7 is an exploded perspective view showing the configuration of a conventional common mode choke coil 200.

The common mode choke coil 200 has a structure in which a low-magnetic-permeability portion 102 is laminated on a first magnetic material portion 101 and a second magnetic material portion 103 is laminated on the low-magnetic-permeability portion 102.

The first magnetic material portion 101 has a structure in which a plurality of magnetic material sheets 101a are laminated.

The low-magnetic-permeability portion 102 has a structure in which a plurality of low-magnetic-permeability sheets 102a are laminated and spiral coil conductors 104a, 104b, 104c, and 104d are each interposed between the two low-magnetic-permeability sheets 102a adjacent in the lamination direction. Each low-magnetic-permeability sheet 102a has a rectangular hole 102b extending therethrough in the lamination direction. In the magnetic material sheet 102a, the hole 102b is formed in a portion corresponding to the inside of the coil conductors 104a to 104d. In addition, predetermined sheets among the low-magnetic-permeability sheets 102a have via conductors 108a and 108b formed in predetermined portions for electrically connecting front and back sides.

Within the low-magnetic-permeability portion 102, the coil conductors 104a and 104b are connected to each other via the via conductor 108a to form a first coil 105a. In addition, the coil conductors 104c and 104d are connected to each other via the via conductor 108b to form a second coil 105b. Then, the first coil 105a and the second coil 105b are electromagnetically coupled to each other to constitute a common mode choke coil.

The second magnetic material portion 103 has a structure in which a plurality of magnetic material sheets 103a are laminated.

On the surface of the common mode choke coil 200, external electrodes 106a, 106b, 106c, and 106d are formed. The external electrode 106a is connected to an end of the coil conductor 104a, the external electrode 106b is connected to an end of the coil conductor 104b, the external electrode 106c is connected to an end of the coil conductor 104c, and the external electrode 106d is connected to an end of the coil conductor 104d.

The common mode choke coil 200 having such a structure is manufactured, for example, through the following processes. First, unfired magnetic material sheets 101a, unfired low-magnetic-permeability sheets 102a, and unfired magnetic material sheets 103a are prepared. Among them, in the low-magnetic-permeability sheets 102a, the holes 102b, the via conductors 108a and 108b, and the coil conductors 104a to 104d are previously formed. A predetermined number of such magnetic material sheets 101a, a predetermined number of such low-magnetic-permeability sheets 102a, and a predetermined number of such magnetic material sheets 103a are laminated in a predetermined order and then press-bonded. The laminate formed thus is fired at a predetermined profile. Then, the external electrodes 106a to 106d are formed on the surface of the fired laminate by burning a conductive paste. In the above manner, the common mode choke coil 200 is manufactured.

When the magnetic material sheets 101a, the low-magnetic-permeability sheets 102a, and the magnetic material sheets 103a are laminated and press-bonded to form the laminate, the magnetic material sheet 101a on the lower side and the magnetic material sheet 103a on the upper side enter the holes 102b formed in the low-magnetic-permeability sheets 102a due to the pressure. In addition, the magnetic material sheet 101a on the lower side and the magnetic material sheet 103a on the upper side are connected to each other within the holes 102b. In other words, the common mode choke coil 200 has a structure in which the first magnetic material portion 101 and the second magnetic material portion 103 are connected to each other by extending in a columnar manner through the low-magnetic-permeability portion 102 present therebetween and the coil conductors 104a to 104d are arranged around the columnar magnetic materials extending through the low-magnetic-permeability portion 102.

However, the common mode choke coil 200 disclosed in Patent Document 1 has a problem that when the amounts of the magnetic material sheet 101a on the lower side and the magnetic material sheet 103a on the upper side which enter the holes 102b of the low-magnetic-permeability sheets 102a are insufficient, both sheets are not connected to each other. In other words, the common mode choke coil 200 does not have a structure in which the first magnetic material portion 101 and the second magnetic material portion 103 are connected to each other by extending through the low-magnetic-permeability portion 102 present therebetween, and thus the common mode choke coil 200 becomes defective.

As a solution to this problem, a solution of previously filling a magnetic material into the holes 102b of the low-magnetic-permeability sheets 102a is conceivable. Such a solution is disclosed, for example, in Patent Document 2 (Japanese Unexamined Patent Application Publication No. 2000-321341). Specifically, a magnetic material is previously filled into holes formed in low-magnetic-permeability sheets (nonmagnetic material sheets). Then, a coil conductor (coil pattern) is inserted between the two low-magnetic-permeability sheets adjacent in a lamination direction. A plurality of lower magnetic material sheets, a plurality of the low-magnetic-permeability sheets between which the coil conductors have been interposed, and a plurality of upper magnetic material sheets are laminated and press-bonded. The laminate formed thus is fired. As a result, a coil is formed within the laminate.

For manufacturing the coil disclosed in Patent Document 2, for example, the following method may be used to fill the magnetic material into the holes formed in the low-magnetic-permeability sheets.

First, a plurality of retaining sheets to be processed are prepared.

Next, a low-magnetic-permeability slurry, namely, a material obtained by kneading a low-magnetic-permeability material, a binder, and a solvent, is applied onto each retaining sheet with a constant thickness, thereby forming a plurality of low-magnetic-permeability sheets.

Next, a frame-shaped blade is pressed against the low-magnetic-permeability sheet on each retaining sheet and separated therefrom. Then, only a low-magnetic-permeability sheet portion corresponding to inside of the blade is removed. By so doing, a hole is formed in each low-magnetic-permeability sheet. In addition, a hole for a via conductor is also formed in some of the low-magnetic-permeability sheets.

Next, a magnetic material slurry, namely, a material obtained by kneading a magnetic material, a binder, and a solvent, is filled into the hole formed in each low-magnetic-permeability sheet. Specifically, from one principal surface side of the low-magnetic-permeability sheet, the magnetic material slurry is applied to the hole formed in the low-magnetic-permeability sheet and the periphery of the hole, thereby filling the magnetic material slurry.

In addition, a conductive paste is filled into the above-described hole for a via conductor.

Next, coil conductors having a predetermined shape are formed on surfaces of predetermined sheets among a plurality of the low-magnetic-permeability sheets by printing a conductive paste. The coil conductors may be formed prior to forming the holes in the low-magnetic-permeability sheets.

At the end, the low-magnetic-permeability sheet in which the magnetic material has been filled is peeled off from each retaining sheet.

A coil manufactured by using the low-magnetic-permeability sheets obtained through such processes has a structure in which a first magnetic material portion and a second magnetic material portion are assuredly connected to each other via a columnar magnetic material formed so as to extend through a low-magnetic-permeability portion.

### SUMMARY

The present disclosure provides a laminated electronic component which allows its productivity to be improved and a method of manufacturing the same.

In an aspect of the present disclosure, a laminated electronic component includes a first magnetic material portion, a low-magnetic-permeability portion laminated on the first magnetic material portion, a second magnetic material portion laminated on the low-magnetic-permeability portion, at least one annular or spiral coil disposed within the low-magnetic-permeability portion, and a plurality of columnar magnetic material portions disposed within the low-magnetic-permeability portion so as to extend through inside of the coil and connect the first magnetic material portion to the second magnetic material portion.

In another aspect of the present disclosure, a method of manufacturing a laminated electronic component includes the steps of preparing a plurality of magnetic material sheets; preparing a plurality of low-magnetic-permeability sheets; forming, in the low-magnetic-permeability sheets, a plurality of holes extending through the low-magnetic-permeability sheets; filling a magnetic material into the plurality of holes; forming an annular or spiral coil conductor on a surface of a predetermined sheet among the plurality of low-magnetic-permeability sheets; laminating a predetermined number of the magnetic material sheets to form a first magnetic material portion; laminating the plurality of low-magnetic-permeability sheets in which the magnetic material has been filled into the holes and the coil conductor has been formed on the surface of the predetermined sheet, on the first magnetic material portion in a predetermined order to form a low-magnetic-permeability portion; laminating a predetermined number of the magnetic material sheets on the low-magnetic-permeability portion to form a second magnetic material portion; and firing a laminate composed of the first magnetic material portion, the low-magnetic-permeability portion, and the second magnetic material portion.

### BRIEF DESCRIPTION OF THE DRAWINGS

FIG. 1 is an exploded perspective view showing a common mode choke coil according to an exemplary embodiment.

FIG. 2A is a cross-sectional view showing an initial process of a method of manufacturing the common mode choke coil in FIG. 1.

FIG. 2B is a cross-sectional view showing a process subsequent to FIG. 2A.

FIG. 2C is a cross-sectional view showing a process subsequent to FIG. 2B.

FIG. 3A is a cross-sectional view showing a process subsequent to FIG. 2C.

FIG. 3B is a cross-sectional view showing a process subsequent to FIG. 3A.

FIG. 3C is a cross-sectional view showing a process subsequent to FIG. 3B.

FIG. 4 is a cross-sectional view showing a process subsequent to FIG. 3C.

FIG. 5A is a cross-sectional view showing a process subsequent to FIG. 4.

FIG. 5B is a cross-sectional view showing a process subsequent to FIG. 5A.

FIG. 6A is a plan view showing a process of peeling off a low-magnetic-permeability sheet from a retaining sheet in the method of manufacturing the common mode choke coil shown in FIG. 1.

FIG. 6B is a plan view of a modification of FIG. 6A.

FIG. 7 is an exploded perspective view showing an existing common mode choke coil.

### DETAILED DESCRIPTION

The inventors realized that the manufacturing method disclosed in Patent Document 2 has a problem that in the process where the low-magnetic-permeability sheet in which the magnetic material has been filled in the hole is peeled off from each retaining sheet, if the opening area of the hole is large, the magnetic material comes off from the hole. In other words, the filled magnetic material remains on the surface of the retaining sheet, and the low-magnetic-permeability sheet in which the hole becomes hollow is peeled off from the retaining sheet. When the cross-sectional area of the hole formed in each low-magnetic-permeability sheet is larger, this problem prominently appears, and the frequency at which the magnetic material comes off from the hole is further increased. A non-defective coil cannot be manufactured by using such low-magnetic-permeability sheets. Thus, the conventional manufacturing method has a problem that high productivity cannot be obtained.

Hereinafter, an exemplary embodiment of the present disclosure that can address the above shortcomings will now be described with reference to the drawings.

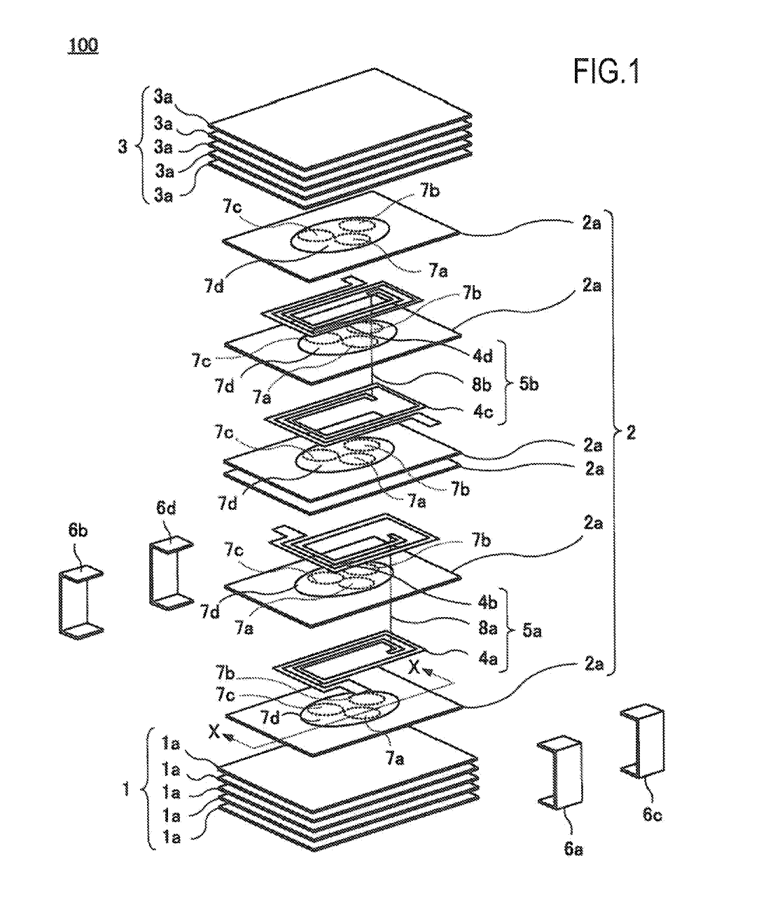

FIG. 1 is an exploded perspective view of a common mode choke coil 100 according to the exemplary embodiment.

The common mode choke coil 100 has a structure in which a low-magnetic-permeability portion 2 is laminated on a first magnetic material portion 1 and a second magnetic material portion 3 is laminated on the low-magnetic-permeability portion 2. The low-magnetic-permeability portion 2 is formed from a material having a lower magnetic permeability than the first magnetic material portion 1, the second magnetic material portion 3, and further penetrating magnetic materials 7a, 7b, and 7c described later, but the material thereof may be a magnetic material or a nonmagnetic material. For example, for the low-magnetic-permeability portion 2, a magnetic material which has a lower magnetic permeability than the first magnetic material portion 1 but is of the same composition type as the first magnetic material portion 1 may be used.

The first magnetic material portion 1 has a structure in which a plurality of magnetic material sheets 1a are laminated. The common mode choke coil 100 according to the embodiment is formed by a laminate being integrally fired as described later, and thus the interfaces between the magnetic material sheets 1a may disappear within the first magnetic material portion 1. As the material of the first magnetic material portion 1, for example, Ni—Cu—Zn ferrite, Mn—Zn ferrite, hexagonal ferrite, and the like can be used.

The low-magnetic-permeability portion 2 has a structure in which a plurality of low-magnetic-permeability sheets 2a are laminated. Here, a spiral coil conductor may be interposed between the two low-magnetic-permeability sheets 2a adjacent in the lamination direction. In FIG. 1, spiral coil conductors 4a to 4d are interposed. Each low-magnetic-permeability sheet 2a has penetrating magnetic materials 7a, 7b, and 7c having circular transverse sections. The penetrating magnetic materials 7a to 7c extend through each low-magnetic-permeability sheet 2a in the lamination direction. The penetrating magnetic materials 7a to 7c are formed in a portion of a principal surface of the magnetic material sheet 2a which corresponds to the inside of the coil conductors 4a to 4d. In the embodiment, for convenience of a manufacturing method, the penetrating magnetic materials 7a to 7c are connected to each other by a film-shaped magnetic material 7d formed on the upper principal surface of each low-magnetic-permeability sheet 2a. In addition, in some of the low-magnetic-permeability sheets 2a, via conductors 8a and 8b are formed in predetermined portions for electrically connecting front and back sides.

A plurality of the low-magnetic-permeability sheets 2a are laminated, the penetrating magnetic materials 7a formed in the respective low-magnetic-permeability sheet 2a are laminated to form one columnar magnetic material portion, the penetrating magnetic materials 7b are laminated to form another columnar magnetic material portion, and the penetrating magnetic materials 7c are laminated to form still another columnar magnetic material portion. That is, three columnar magnetic material portions are formed in total.

As the material of the low-magnetic-permeability portion 2, for example, a nonmagnetic material such as glass ceramics having a magnetic permeability of about 1, Ni—Cu—Zn ferrite having a magnetic permeability of about 1 to 10, nonmagnetic ferrite, and the like can be used. In addition, as the penetrating magnetic materials 7a, 7b, and 7c, the same material as that of the first magnetic material portion 1 as described above can be used. Furthermore, as the material of the coil conductors 4a to 4d and the via conductors 8a and 8b, for example, a metal such as Cu, Pd, Al, and Ag or an alloy containing at least one of these metals can be used. The common mode choke coil 100 according to the embodiment is formed by a laminate being integrally fired as described later, and thus the interfaces between the low-magnetic-permeability sheets 2a or the interfaces between the penetrating magnetic materials 7a, between the penetrating magnetic materials 7b, or between the penetrating magnetic materials 7c may disappear within the low-magnetic-permeability portion 2.

Within the low-magnetic-permeability portion 2, the coil conductor 4a and the coil conductor 4b are connected to each other via the via conductor 8a to form a first coil 5a. In addition, the coil conductor 4c and the coil conductor 4d are connected to each other via the via conductor 8b to form a second coil 5b. The first coil 5a and the second coil 5b are electromagnetically coupled to each other to constitute a common mode choke coil. The second magnetic material portion 3 has a structure in which a plurality of magnetic material sheets 3a are laminated. As the material of the second magnetic material portion 3, the same material as that of the first magnetic material portion 1 can be used. The common mode choke coil 100 according to the embodiment is formed by a laminate being integrally fired as described later, and thus the interfaces between the magnetic material sheets 3a may disappear within the second magnetic material portion 3.

External electrodes 6a, 6b, 6c, and 6d are formed on the surface of the common mode choke coil 100. The external electrode 6a is connected to an end of the coil conductor 4a, the external electrode 6b is connected to an end of the coil conductor 4b, the external electrode 6c is connected to an end of the coil conductor 4c, and the external electrode 6d is connected to an end of the coil conductor 4d. As the material of the external electrodes 6a, 6b, 6c, and 6d, for example, a metal such as Cu, Pd, Al, and Ag or an alloy containing at least one of these metals can be used.

In the common mode choke coil 100 according to the embodiment, within the low-magnetic-permeability portion 2, the three columnar magnetic material portions, namely, the laminate of the penetrating magnetic materials 7a, the laminate of the penetrating magnetic materials 7b, and the laminate of the penetrating magnetic materials 7c, are formed, and they connect the first magnetic material portion 1 to the second magnetic material portion 3. The transverse section of each columnar magnetic material portion is small, but the sum of the cross-sectional areas of the three columnar magnetic material portions is equivalent to that in the related art. Therefore, electrical properties equivalent to those in the related art can be obtained.

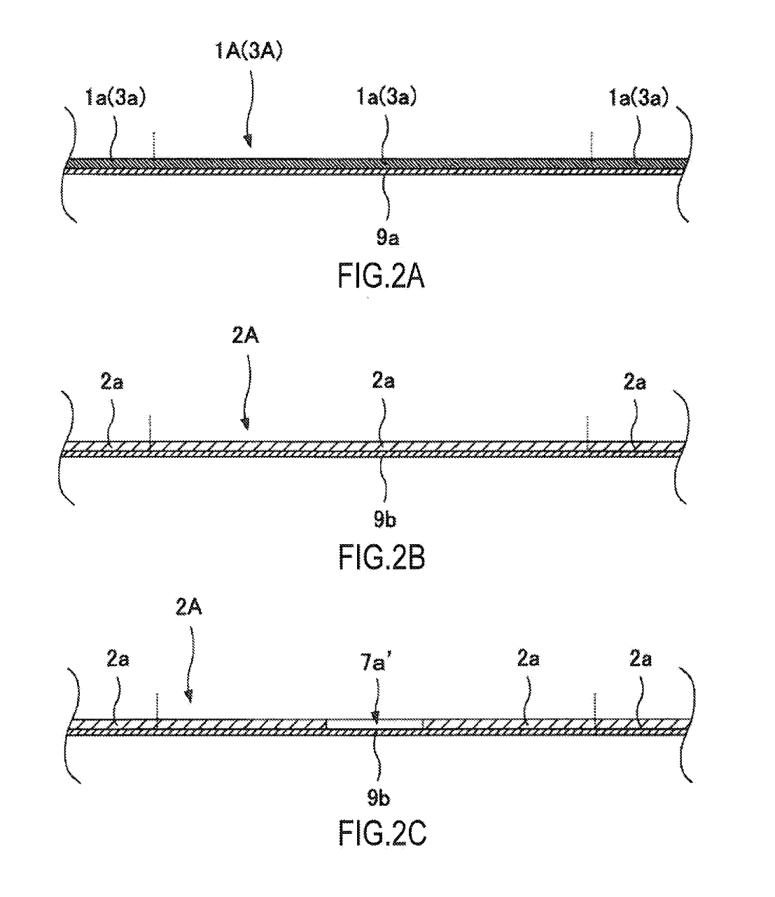

Next, an example of a method of manufacturing the common mode choke coil 100 according to the embodiment will be described with reference to FIGS. 2A to 5B.

First, as shown in FIG. 2A, a retaining sheet 9a, which is formed from PET (polyethylene terephthalate) or the like and is to be processed, is prepared. A magnetic material slurry is applied onto the retaining sheet 9a with a predetermined thickness to produce a mother magnetic material sheet 1A (3A) in which a large number of magnetic material sheets 1a or 3a are arranged in a matrix manner. In FIG. 2A, the interfaces between the adjacent magnetic material sheets 1a (3a) of the mother magnetic material sheet 1A (3A) are indicated by chain lines. The magnetic material slurry is applied, for example, by a doctor blade method. A plurality of the mother magnetic material sheets 1A (3A) as described above are produced according to need.

In addition, as shown in FIG. 2B, a retaining sheet 9b, which is formed from PET or the like and is to be processed, is prepared. A low-magnetic-permeability slurry is applied onto the retaining sheet 9b with a predetermined thickness to produce a mother low-magnetic-permeability sheet 2A in which a large number of low-magnetic-permeability sheets 2a are arranged in a matrix manner. In FIG. 2B, the interfaces between the adjacent low-magnetic-permeability sheets 2a of the mother low-magnetic-permeability sheet 2A are indicated by chain lines (the same applies to the following drawings). The low-magnetic-permeability slurry is applied, for example, by a doctor blade method. A plurality of the mother low-magnetic-permeability sheets 2A as described above are produced according to need.

Next, as shown in FIG. 2C, three holes 7a′ to 7c′ for forming the penetrating magnetic materials 7a to 7c are formed in each low-magnetic-permeability sheet 2a of the mother low-magnetic-permeability sheet 2A. FIG. 2C shows a cross section corresponding to a portion of the low-magnetic-permeability sheet 2a taken along a broken-line arrow X-X in FIG. 1, and thus only the hole 7a′ appears and the holes 7b′ and 7c′ do not appear in FIG. 2C. The holes 7a′ to 7c′ are formed, for example, by pressing an annular blade against each low-magnetic-permeability sheet 2a formed on the retaining sheet 9b, separating the blade therefrom, and removing a low-magnetic-permeability sheet portion corresponding to inside of the blade.

In addition, although not shown, a hole 8a′ or 8b′ for forming the via conductor 8a or 8b is formed in each low-magnetic-permeability sheet 2a formed in a portion of the mother low-magnetic-permeability sheet 2A. The hole 8a′ or 8b′ is formed, for example, by applying a laser beam.

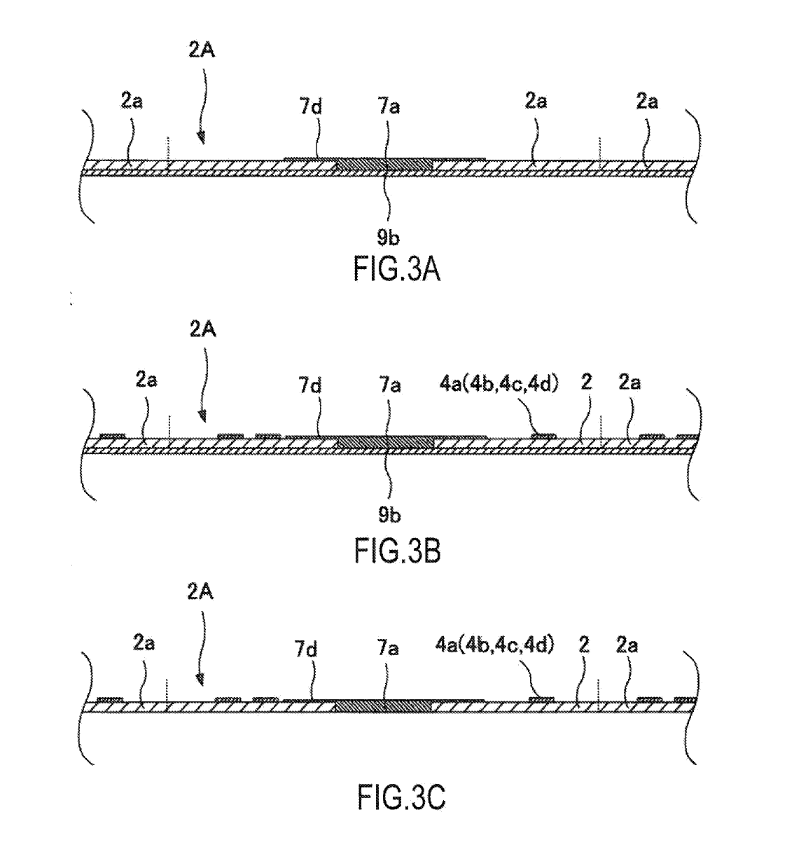

Next, as shown in FIG. 3A, the magnetic material slurry is filled into the three holes 7a′ to 7c′ formed in each low-magnetic-permeability sheet 2a of the mother low-magnetic-permeability sheet 2A, whereby the penetrating magnetic materials 7a to 7c are formed. The magnetic material slurry is filled, for example, by a screen printing method.

In the embodiment, at that time, the circular film-shaped magnetic material 7d is formed in a region on the upper principal surface of each low-magnetic-permeability sheet 2a which includes the holes 7a′ to 7c′. The film-shaped magnetic material 7d is connected to each of the penetrating magnetic materials 7a to 7c. The film-shaped magnetic material 7d is not an essential component in the embodiment, and the magnetic material slurry may be supplied into only the holes 7a′ to 7c′. FIG. 3A shows a cross section corresponding to the portion of the low-magnetic-permeability sheet 2a taken along the broken-line arrow X-X in FIG. 1, and thus only the penetrating magnetic material 7a appears and the penetrating magnetic materials 7b and 7c do not appear in FIG. 3A.

In addition, although not shown, a conductive paste is filled into the hole 8a′ or 8b′ formed in the portion of the mother low-magnetic-permeability sheet 2A, whereby the via conductor 8a or 8b is formed. The conductive paste is filled, for example, by a screen printing method.

Next, as shown in FIG. 3B, any one of the coil conductors 4a to 4d is formed on each low-magnetic-permeability sheet 2a formed in the portion of the mother low-magnetic-permeability sheet 2A. The coil conductors 4a to 4d are formed, for example, by screen printing the conductive paste into a desired shape. The coil conductors 4a to 4d have shapes different from each other.

Next, although not shown, the mother magnetic material sheets 1A and 3A are peeled off from the retaining sheets 9a.

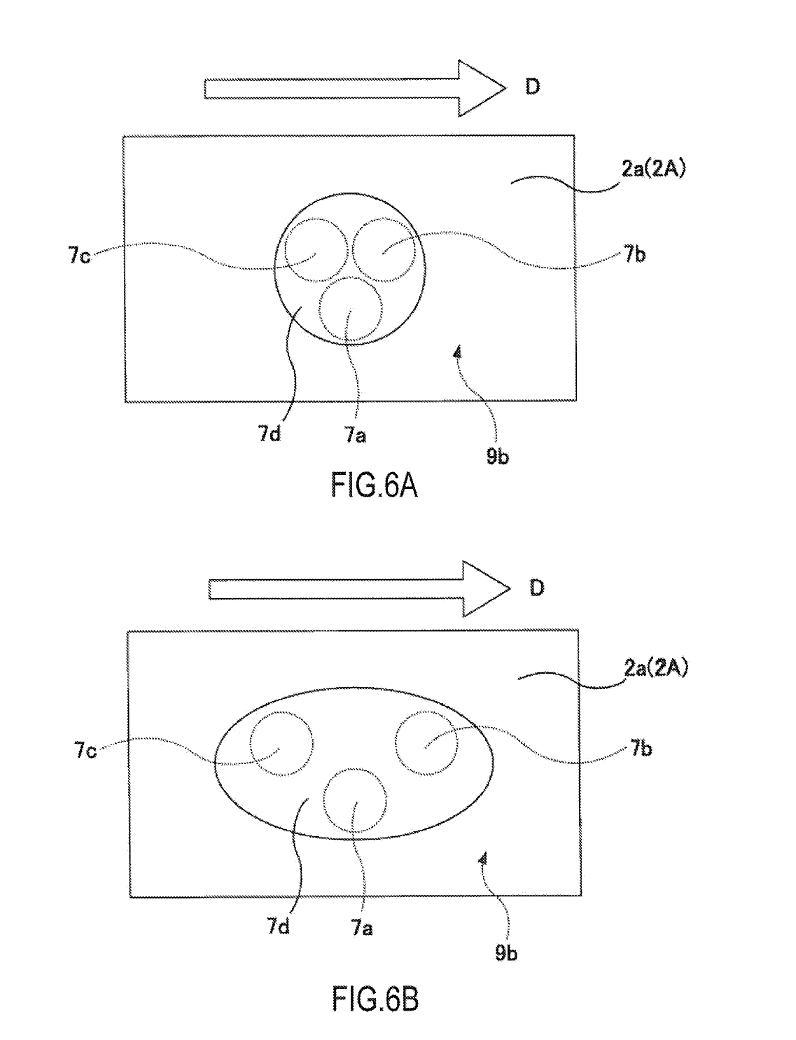

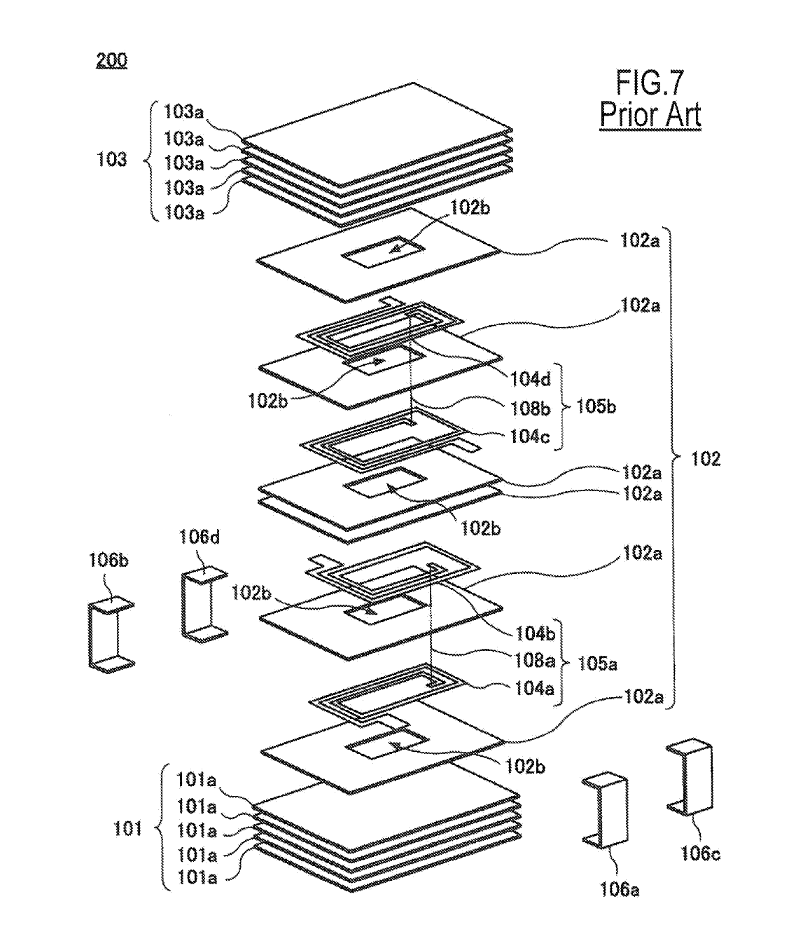

In addition, as shown FIG. 3C, the mother low-magnetic-permeability sheet 2A is peeled off from the retaining sheet 9b. The process of peeling off the mother low-magnetic-permeability sheet 2A from the retaining sheet 9b will be separately described with reference to the plan view of FIG. 6A. FIG. 6A shows one low-magnetic-permeability sheet 2a in the mother low-magnetic-permeability sheet 2A, and thus a description will be given below with the low-magnetic-permeability sheet 2a as one unit.

As shown in FIG. 6A, when the low-magnetic-permeability sheet 2a is peeled off from the retaining sheet 9b in an arrow D direction, the penetrating magnetic material 7c initially starts being peeled off. Subsequently, while the penetrating magnetic material 7c is peeled off, the penetrating magnetic material 7a starts being peeled off. Subsequently, after the penetrating magnetic material 7c is completely peeled off and while the penetrating magnetic material 7a is peeled off, the penetrating magnetic material 7b starts being peeled off. As described above, the penetrating magnetic materials 7a to 7c are preferably peeled off in order at different timings. When a portion where the penetrating magnetic materials 7a to 7c are present (a portion where the holes are present) is peeled off, an unstable tensile force is applied to the low-magnetic-permeability sheet 2a. Thus, the low-magnetic-permeability sheet 2a is easily broken when the penetrating magnetic materials 7a to 7c are simultaneously peeled off. However, when the penetrating magnetic materials 7a to 7c are peeled off in order at different timings, breaking of the low-magnetic-permeability sheet 2a can be prevented.

As shown in FIG. 6B, the formed positions of the penetrating magnetic materials 7a to 7c may be changed to positions different from those in the example of FIG. 6A. In the example of FIG. 6B, the penetrating magnetic materials 7a to 7c are formed such that the penetrating magnetic material 7a starts being peeled off after the penetrating magnetic material 7c is completely peeled off and the penetrating magnetic material 7b starts being peeled off after the penetrating magnetic material 7a is completely peeled off. With this configuration, the effect of preventing the low-magnetic-permeability sheet 2a from being broken is further enhanced.

As described above, although the low-magnetic-permeability sheet 2a, namely, the mother low-magnetic-permeability sheet 2A, is peeled off from the retaining sheet 9b, a columnar magnetic material portion formed within the low-magnetic-permeability portion 2 is divided into a plurality of portions and the transverse sectional area of each portion is small in the embodiment. Thus, the surface area of each of the penetrating magnetic materials 7a to 7c formed in the low-magnetic-permeability sheet 2a is also small, and hence when the low-magnetic-permeability sheet 2a is peeled off from the retaining sheet 9b, the penetrating magnetic materials 7a to 7c are unlikely to remain on the retaining sheet 9b, and the possibility is reduced that the penetrating magnetic materials 7a to 7c come off from the low-magnetic-permeability sheet 2a.

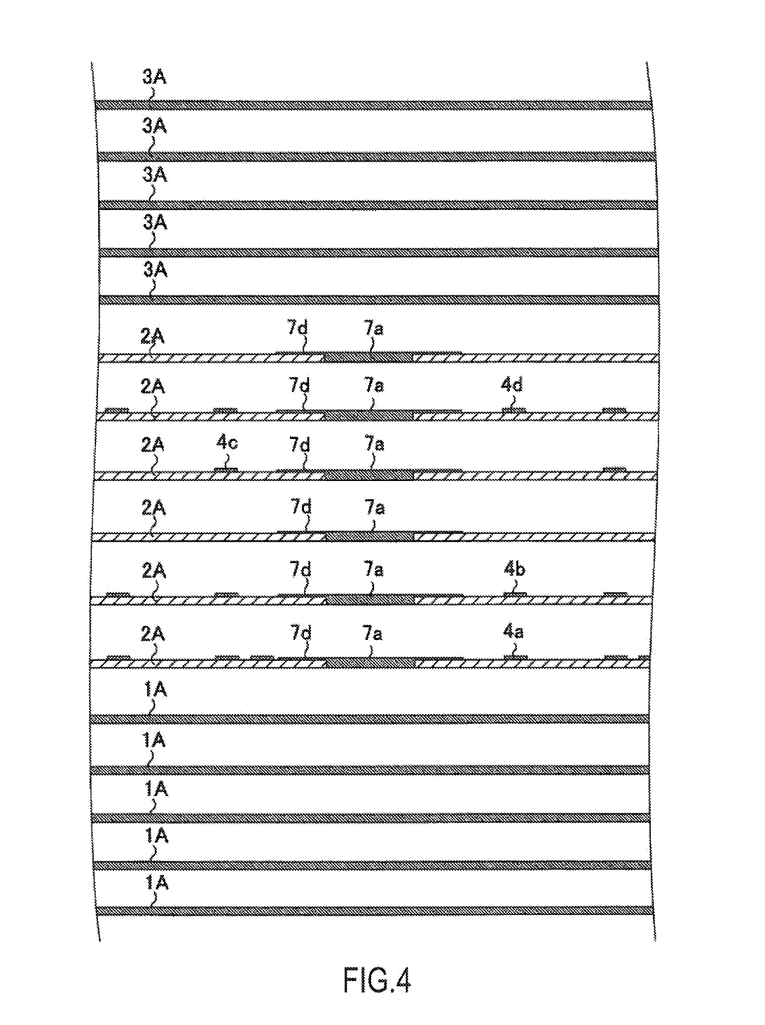

Next, as shown in FIG. 4, a plurality of the mother magnetic material sheets 1A, a plurality of the mother low-magnetic-permeability sheets 2A, and a plurality of the mother magnetic material sheets 3A are laminated.

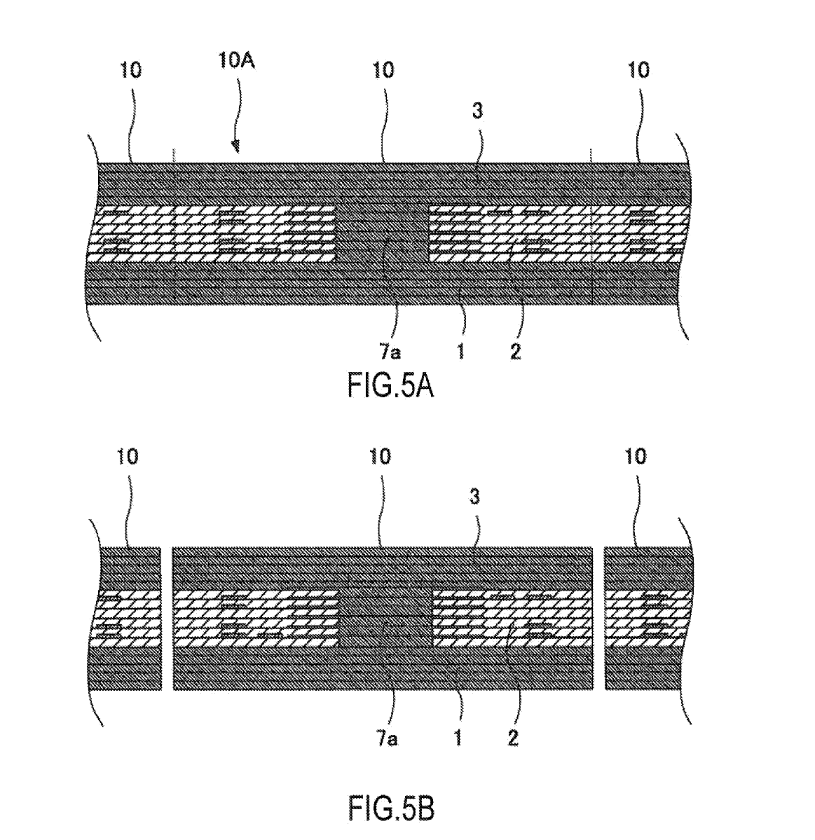

Next, as shown in FIG. 5A, the laminated mother magnetic material sheets 1A, mother low-magnetic-permeability sheets 2A, and mother magnetic material sheets 3A are integrated by pressure bonding to form an unfired mother laminate 10A.

Next, although not shown, the unfired mother laminate 10A is fired at a predetermined profile to produce a fired mother laminate 10A.

Next, as shown in FIG. 5B, the fired mother laminate 10A is divided into individual laminates 10. The division into the individual laminates may be conducted prior to the above firing.

At the end, although not shown, the external electrodes 6a to 6d are formed on the surface of each laminate 10 obtained by the division, to complete the common mode choke coil 100. The external electrodes 6a to 6d are formed, for example, by applying a conductive paste into a desired shape and firing the conductive paste.

The structure of the common mode choke coil 100 according to the exemplary embodiment and the example of the manufacturing method thereof has been described above. However, embodiments consistent with the present disclosure are not limited to the above contents, and various modifications can be made according to the principles of the present disclosure.

For example, the laminated electronic component is not limited to the common mode choke coil, and may be another type of a coil component or another type of an electronic component including a coil therein. In addition, the laminated electronic component is not limited to a component including two coils as in a common mode choke coil, and may be a component including a single coil or three or more coils.

In addition, the number of the columnar magnetic materials formed within the low-magnetic-permeability portion is not limited to three, and may be two or four or more.

Furthermore, the shape of the transverse section of each columnar magnetic material formed within the low-magnetic-permeability portion is not limited to a circular shape, and may be, for example, elliptical, rectangular, or other polygonal shape.

The inventors conducted the following experiment in order to confirm that the laminated electronic component according to the present disclosure has electrical properties equivalent to those of an existing one and that even when one of a plurality of the columnar magnetic material portions becomes non-penetrating, deterioration of the electrical properties is lower than when a columnar magnetic material portion of a laminated electronic component having only the single columnar magnetic material portion becomes non-penetrating.

As an example, the common mode choke coil 100 according to the exemplary embodiment described above was prepared. The diameter of each of the three columnar magnetic material portions of the common mode choke coil 100, namely, the laminate of the penetrating magnetic materials 7a, the laminate of the penetrating magnetic materials 7b, and the laminate of the penetrating magnetic materials 7c, was set to 0.065 mm.

In addition, as a comparative example, a common mode choke coil including one columnar magnetic material portion within a low-magnetic-permeability portion 2 was prepared. The transverse section of the columnar magnetic material portion was set to 0.12 mm×0.10 mm. Other than this, there is no difference between the example and the comparative example. More specifically, the configuration of the other portion is the same as that of the example, and the manufacturing method is also the same as that of the example.

The sum of the transverse sectional areas of the three columnar magnetic material portions of the example is 0.01 mm², the transverse sectional area of the columnar magnetic material portion of the comparative example is 0.012 mm², and both are substantially equal to each other.

The inventors measured a common-mode impedance (Ω) at 100 MHz with an impedance analyzer for the example and the comparative example. As a result, as shown in Table 1, the common-mode impedance was 160Ω in the example and 180Ω in the comparative example, and the electrical properties of both examples were substantially equal to each other.

TABLE 1

| | Common mode impedance (Ω) | | |
|---|---|---|---|
| | Penetrating | Non-penetrating | |
| | magnetic path | magnetic path | Change rate |
| Example | 160 | 130* | −19% |
| Comparative | 180 | 85 | −53% |
| example | | | |

*Case where one of three columnar magnetic material portions became non-penetrating.

Next, the inventors measured a common-mode impedance (Ω) at 100 MHz by simulation using an electromagnetic field simulator, when one of the three columnar magnetic material portions became non-penetrating in the example, and when the columnar magnetic material portion became non-penetrating in the comparative example.

As a result, as shown in Table 1, the common-mode impedance was 130Ω in the example and 85Ω in the comparative example. Whereas the change rate in the comparative example when the columnar magnetic material portion became non-penetrating was −53%, the change rate in the example when one of the columnar magnetic material portions became non-penetrating was −19%. Thus, it is recognized that the example has higher robustness when the columnar magnetic material portion becomes non-penetrating, than the comparative example.

What is claimed is:

1. A laminated electronic component comprising:
a first magnetic material portion;
a low-magnetic-permeability portion laminated on the first magnetic material portion;
a second magnetic material portion laminated on the low-magnetic-permeability portion;
at least one annular or spiral coil disposed within the low-magnetic-permeability portion; and
a plurality of columnar magnetic material portions disposed within the low-magnetic-permeability portion so as to extend through inside of the coil and connect the first magnetic material portion to the second magnetic material portion.

2. The laminated electronic component according to claim 1, wherein the coil includes a pair of coils which are electromagnetically coupled to each other to constitute a common mode choke coil.

3. The laminated electronic component according to claim 1, wherein each of the columnar magnetic material portions has a circular transverse section.

4. The laminated electronic component according to claim 2, wherein each of the columnar magnetic material portions has a circular transverse section.

5. A method of manufacturing a laminated electronic component, the method comprising the steps of:
preparing a plurality of magnetic material sheets;
preparing a plurality of low-magnetic-permeability sheets;
forming, in the low-magnetic-permeability sheets, a plurality of holes extending through the low-magnetic-permeability sheets;
filling a magnetic material into the plurality of holes;
forming an annular or spiral coil conductor on a surface of a predetermined sheet among the plurality of low-magnetic-permeability sheets;
laminating a predetermined number of the magnetic material sheets to form a first magnetic material portion;
laminating the plurality of low-magnetic-permeability sheets in which the magnetic material has been filled into the holes and the coil conductor has been formed on the surface of the predetermined sheet, on the first magnetic material portion in a predetermined order to form a low-magnetic-permeability portion;
laminating a predetermined number of the magnetic material sheets on the low-magnetic-permeability portion to form a second magnetic material portion; and
firing a laminate composed of the first magnetic material portion, the low-magnetic-permeability portion, and the second magnetic material portion.

6. The method according to claim 5, wherein
the step of filling the magnetic material into the plurality of holes is conducted in a state where each low-magnetic-permeability sheet is attached to a retaining sheet, and
the retaining sheet is peeled off from the low-magnetic-permeability sheet after the magnetic material is filled.

7. The method according to claim 6, wherein in peeling off the low-magnetic-permeability sheet from the retaining sheet, portions of the low-magnetic-permeability sheet where the plurality of holes into which the magnetic material has been filled are present are peeled off in order at different timings.

8. The method according to claim 5, wherein the plurality of holes are positioned on each low-magnetic-permeability sheet in an area surrounded by the annular or spiral coil conductor when viewed in a direction of the lamination.
